(19) United States
(12) Patent Application Publication
(10) Pub. No.: US 2023/0100780 A1
(43) Pub. Date: Mar. 30, 2023

(54) SOLID STATE BATTERY

(71) Applicant: Murata Manufacturing Co., Ltd., Nagaokakyo-shi (JP)

(72) Inventor: Koichi NAKANO, Nagaokakyo-shi (JP)

(21) Appl. No.: 18/062,070

(22) Filed: Dec. 6, 2022

Related U.S. Application Data
(63) Continuation of application No. PCT/JP2021/022312, filed on Jun. 11, 2021.

(30) Foreign Application Priority Data
Jun. 15, 2020 (JP) 2020-103168

(51) Int. Cl. H01M 4/36; H01M 50/548; H01M 50/531

(52) U.S. Cl. CPC H01M 4/366; H01M 50/548; H01M 50/531; H01M 2004/027

(57) ABSTRACT

A solid state battery that includes: a solid state battery laminate that includes at least one battery constituent unit including a positive electrode layer, a negative electrode layer, and a solid electrolyte layer interposed between the positive electrode layer and the negative electrode layer; a positive electrode terminal on a first side surface of the solid state battery laminate; a negative electrode terminal on a second side surface opposite the first side surface of the solid state battery laminate; and an insulating part having a sleeve shape in a sectional view of the solid state battery, the insulating part covering an active material part of at least one electrode layer of the positive electrode layer and the negative electrode layer in a boundary region with the external terminal.

### CROSS REFERENCE TO RELATED APPLICATIONS

The present application is a continuation of International application No. PCT/JP2021/022312, filed Jun. 11, 2021, which claims priority to Japanese Patent Application No. 2020-103168, filed Jun. 15, 2020, the entire contents of each of which are incorporated herein by reference.

### FIELD OF THE INVENTION

The present invention relates to a solid state battery. More specifically, the present invention relates to a solid state battery in which an insulating part is laminated on an electrode layer in a boundary region between the electrode layer and an external terminal of the solid state battery.

### BACKGROUND OF THE INVENTION

Conventionally, secondary batteries that can be repeatedly charged and discharged have been used for various purposes. For example, the secondary battery is used as a power supply of an electronic device such as a smartphone and a notebook computer.

In a secondary battery, a liquid electrolyte is generally used as a medium for ion transfer that contributes to charge and discharge. That is, a so-called “electrolytic solution” is used for the secondary battery. However, in such a secondary battery, safety is generally required in terms of preventing leakage of an electrolytic solution. Furthermore, since an organic solvent or the like used for the electrolytic solution is a flammable substance, safety is also required in that respect.

Therefore, studies have been conducted on a solid state battery using a solid electrolyte instead of an electrolytic solution.

Patent Document 1: Japanese Patent Application Laid-Open No. 2019-87347

### SUMMARY OF THE INVENTION

The inventors of the present application have noticed that conventional solid state batteries have problems to be overcome, and have found the need to take measures therefor. Specifically, the inventors of the present application have found that there are the following problems.

For example, as illustrated in FIG. 12, a conventional solid state battery 100 includes a solid state battery laminate 150 including at least one battery constituent unit along a lamination direction, the battery constituent unit including a positive electrode layer 110, a negative electrode layer 120, and a solid electrolyte layer 130 interposed therebetween. Moreover, the solid state battery 100 includes, as external terminals, positive electrode terminal 160A and negative electrode terminal 160B provided on opposing side surfaces or end surfaces (more specifically, left and right side surfaces or end surfaces) of the solid state battery laminate 150. The positive electrode terminal 160A is electrically connected to the positive electrode layer 110, and the negative electrode terminal 160B is electrically connected to the negative electrode layer 120.

For example, as illustrated in FIG. 12, in the conventional solid state battery 100, an insulating part (or also referred to as an electrode separation part or a margin layer) 140 can be provided between the positive electrode layer 110 and the negative electrode terminal 160B and between the negative electrode layer 120 and the positive electrode terminal 160A in order to prevent an electrical short circuit.

Here, in the solid state battery, it is generally desirable that each layer can be formed by firing, and further, the solid state battery laminate forms an integrally sintered body. Therefore, it is desirable that the solid state battery laminate is manufactured by a lamination technique such as a printing method such as a screen printing method or a green sheet method using a green sheet.

However, according to the research of the inventors of the present application, it has been found that, according to a method of manufacturing a solid state battery using such a lamination technique, particularly a printing method or the like, in the lamination stage of each layer, that is, in the lamination of the “positive electrode layer”, the “negative electrode layer” and the “solid electrolyte layer” or the formation of the “insulating part”, for example, the following problems (1) to (3) are likely to occur (See also FIG. 12.).

(1) Short Circuit Between Electrode Layers

In the vicinity of the insulating part, when the positive electrode layer 110 is formed by a printing method or the like, the positive electrode layer 110 (specifically, a paste for forming the positive electrode layer 110) rises or swells, and is likely to be electrically short-circuited in proximity to the negative electrode layer 120 which may be located and formed above in the lamination direction. Furthermore, similarly, when the negative electrode layer 120 is formed by a printing method or the like, the negative electrode layer 120 (specifically, a paste for forming the negative electrode layer 120) rises or swells, and is likely to be electrically short-circuited in proximity to the positive electrode layer 110 which may be located and formed above in the lamination direction.

(2) Short Circuit Between Electrode Layer and External Terminal

In the vicinity of the insulating part, when the positive electrode layer 110 is formed by a printing method or the like, the positive electrode layer 110 (specifically, a paste for forming the positive electrode layer 110) extends toward the negative electrode terminal 160B, and is likely to be electrically short-circuited in proximity to the negative electrode terminal 160B. Furthermore, similarly, when the negative electrode layer 120 is formed by a printing method or the like, the negative electrode layer 120 (specifically, a paste for forming the negative electrode layer 120) extends toward the positive electrode terminal 160A, and is likely to be electrically short-circuited in proximity to the positive electrode terminal 160A.

(3) Delamination of Electrode Layer

In the vicinity of the insulating part, physical delamination of the positive electrode layer 110, particularly interlayer delamination is likely to occur during manufacturing of the solid state battery and charging and discharging of the solid state battery due to the structure. Furthermore, similarly, the negative electrode layer 120 is also likely to cause physical delamination, particularly interlayer delamination, in the vicinity of the insulating part.

All of the above problems are considered to cause a decrease in performance of the solid state battery.

Furthermore, it was also found by the research of the inventors of the present application that the above problems become particularly remarkable when an electrode layer is multilayered by disposing a current collecting layer (more specifically, a positive electrode current collecting layer 211 and the like) in the electrode layer, for example, as illustrated in FIG. 13.

The invention of the present application has been made in view of such problems. That is, a main object of the present invention is to provide a solid state battery in which a short circuit between electrode layers, a short circuit between an electrode layer and an external terminal, and delamination of the electrode layer are further suppressed.

The inventors of the present application have attempted to solve the above problems by addressing the problems in a new direction instead of addressing the problems in an extension of the conventional technique. As a result, the inventors have reached the invention of a solid state battery in which the above main object has been achieved.

According to the present invention, there is provided a solid state battery including: a solid state battery laminate that includes at least one battery constituent unit including a positive electrode layer, a negative electrode layer, and a solid electrolyte layer interposed between the positive electrode layer and the negative electrode layer; a positive electrode terminal on a first side surface of the solid state battery laminate; a negative electrode terminal on a second side surface opposite the first side surface of the solid state battery laminate; and an insulating part having a sleeve shape in a sectional view of the solid state battery, the insulating part covering an active material part of at least one electrode layer of the positive electrode layer and the negative electrode layer in a boundary region with the external terminal.

For example, as illustrated in FIG. 1, in a solid state battery according to an embodiment of the present invention, an electrode layer (1, 2) has a configuration in which an active material part (1′, 2′) that can be included in at least one electrode layer (1, 2) and an insulating part 4 or a part thereof are laminated on each other in a boundary region X with an external terminal 6, and the insulating part 4 covers the active material part (1′, 2′) in a “sleeve shape” in a sectional view. In other words, in the at least one electrode layer (1, 2), the insulating part 4, particularly the “sleeve-shaped” part (S) thereof vertically overlaps the electrode layer (1, 2), particularly the active material part (1′, 2′), and particularly, is in contact with a principal surface of the electrode layer (1, 2), particularly a principal surface of the active material part (1′, 2′), so that the insulating part 4 can be disposed outside in the lamination direction or in an up-down direction of the electrode layer (1, 2).

In the present invention, it is possible to obtain a solid state battery in which a short circuit between electrode layers, a short circuit between an electrode layer and an external terminal, and delamination of the electrode layer are further suppressed. Note that the effects described in the present specification are merely examples and are not limited, and additional effects may be provided.

### BRIEF EXPLANATION OF THE DRAWINGS

FIG. 1 is a schematic sectional view schematically illustrating a boundary region of a solid state battery according to an embodiment of the present invention.

FIG. 2 is a schematic sectional view schematically illustrating the solid state battery according to the first embodiment of the present invention.

FIG. 3 is a schematic sectional view schematically illustrating the boundary region of the solid state battery according to the first embodiment of the present invention.

FIG. 4 is a schematic sectional view schematically illustrating a solid state battery according to a second embodiment of the present invention.

FIG. 5 is a schematic sectional view schematically illustrating a boundary region of the solid state battery according to the second embodiment of the present invention.

FIG. 6 is a schematic sectional view schematically illustrating a solid state battery according to a third embodiment of the present invention.

FIG. 7 is a schematic sectional view schematically illustrating a boundary region of the solid state battery according to the third embodiment of the present invention.

FIG. 8 is a schematic sectional view schematically illustrating a solid state battery according to a fourth embodiment of the present invention.

FIG. 9 is a schematic sectional view schematically illustrating a boundary region of the solid state battery according to the fourth embodiment of the present invention.

FIG. 10 is a schematic diagram schematically illustrating formation of an insulating part.

FIG. 11 is a schematic diagram schematically illustrating formation of another insulating part.

FIG. 12 is a schematic sectional view schematically illustrating a conventional solid state battery.

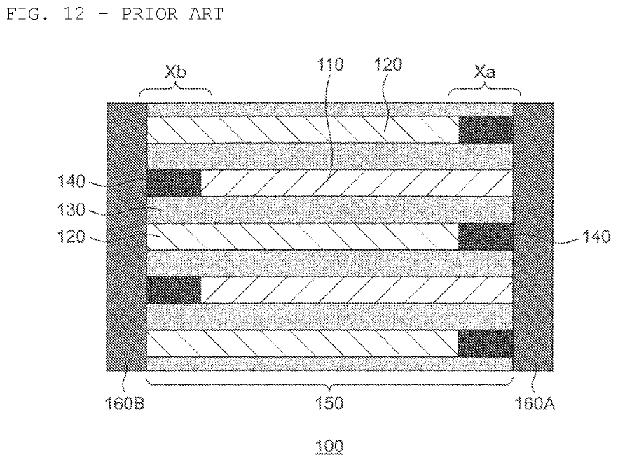

FIG. 13 is a schematic sectional view schematically illustrating another conventional solid state battery.

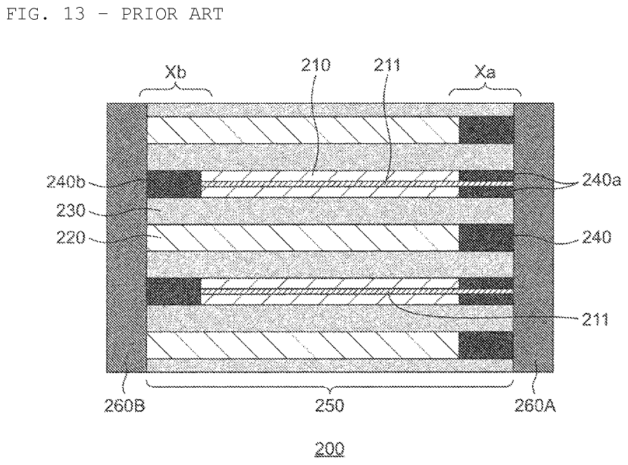

### DETAILED DESCRIPTION OF THE INVENTION

Hereinafter, a “solid state battery” of the present invention will be described in detail. Although the description will be made with reference to the drawings as necessary, the illustrated contents are only schematically and exemplarily illustrated for the understanding of the present invention, and the appearance and/or the dimensional ratio and the like may be different from the actual ones.

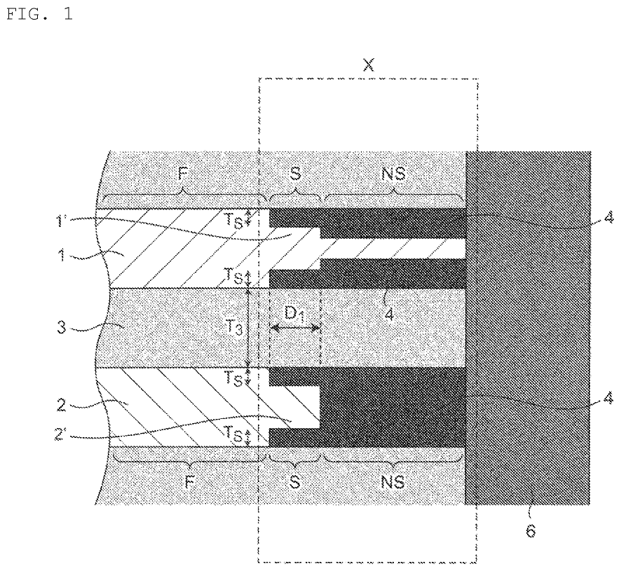

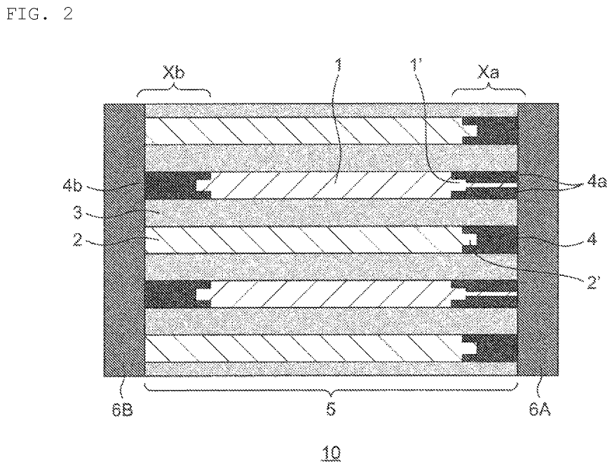

The term “sectional view” as used in the present specification is based on a form when viewed from a direction substantially perpendicular to a thickness direction based on a lamination direction or a stacking direction of layers that can constitute a solid state battery. In other words, it is based on a form in the case of cutting along a plane parallel to the thickness direction. In short, it is based on the form of the section of the object illustrated, for example, in FIGS. 1 and 2. An “up-down direction” and a “left-right direction” used directly or indirectly in the present specification correspond to an up-down direction and a left-right direction in the drawings, respectively. Unless otherwise specified, the same reference symbols or signs denote the same members or parts or the same semantic contents. In a preferred aspect, it can be understood that a downward direction in a vertical direction (that is, a direction in which gravity acts) corresponds to a “downward direction”/a “bottom surface side”, and an opposite direction thereof corresponds to an “upward direction”/a “top surface side”.

The term “solid state battery” as used in the present invention refers in a broad sense to a battery whose constituent elements can be composed of a solid, and in a narrow sense to an all-solid state battery whose constituent elements (particularly preferably all constituent elements) can be composed of a solid. In a preferred aspect, the solid state battery in the present invention is a laminated solid state battery configured such that layers constituting a battery constituent unit are laminated with each other, and preferably, such layers are composed of a sintered body. Note that the “solid state battery” can include not only a so-called “secondary battery” capable of repeating charging and discharging but also a “primary battery” capable of only discharging. According to a preferred aspect of the present invention, the “solid state battery” is a secondary battery. The “secondary battery” is not excessively limited by its name, and may include, for example, a power storage device and the like.

Hereinafter, first, a basic configuration of a “solid state battery” of the present invention will be described, and then characteristics (particularly, an “insulating part”) of the solid state battery of the present invention will be described. The basic configuration of the solid state battery described here is merely an example for understanding the invention, and does not limit the invention.

[Basic Configuration of solid State Battery]

The solid state battery includes at least electrode layers of a positive electrode and a negative electrode and a solid electrolyte layer (or solid electrolyte). More specifically, for example, as illustrated in FIG. 2, the solid state battery includes a solid state battery laminate (5) including at least one battery constituent unit along a lamination direction, the at least one battery constituent unit including a positive electrode layer (1), a negative electrode layer (2), and a solid electrolyte layer (or solid electrolyte) (3) interposed at least between the positive electrode layer (1) and the negative electrode layer (2).

Preferably, each layer that can constitute the solid state battery may be formed by firing, and the positive electrode layer, the negative electrode layer, the solid electrolyte layer, and the like may form a sintered layer. More preferably, the positive electrode layer, the negative electrode layer, and the solid electrolyte layer are each fired integrally with each other, and thus the battery constituent unit or the solid state battery laminate may form an integrally sintered body.

The positive electrode layer (1) is an electrode layer containing at least a positive electrode active material. Therefore, the positive electrode layer (1) may be a positive electrode active material layer mainly composed of a positive electrode active material. The positive electrode layer may further contain a solid electrolyte as necessary. In one aspect, the positive electrode layer may be composed of a sintered body containing at least positive electrode active material particles and solid electrolyte particles.

The negative electrode layer (2) is an electrode layer containing at least a negative electrode active material. Therefore, the negative electrode layer (2) may be a negative electrode active material layer mainly composed of a negative electrode active material. The negative electrode layer may further contain a solid electrolyte as necessary. In one aspect, the negative electrode layer may be composed of a sintered body containing at least negative electrode active material particles and solid electrolyte particles.

The positive electrode active material and the negative electrode active material are materials that can be involved in occlusion and release of ions and transfer of electrons to and from an external circuit in a solid state battery. Through the solid electrolyte, ions move (conduct) between the positive electrode layer and the negative electrode layer. The occlusion and release of ions in an active material is accompanied by oxidation or reduction of the active material, but charging and discharging can proceed as electrons or holes for such oxidation-reduction reaction are transferred from an external circuit to an external terminal, and further to the positive electrode layer or the negative electrode layer. The positive electrode layer and the negative electrode layer are layers capable of occluding and releasing, for example, lithium ions, sodium ions, protons (H⁺), potassium ions (K⁺), magnesium ions (Mg²⁺), aluminum ions (Al³⁺), silver ions (Ag⁺), fluoride ions (F⁻), or chloride ions (Cl⁻). That is, the solid state battery is preferably an all-solid state secondary battery in which the ions can move between the positive electrode layer and the negative electrode layer via the solid electrolyte to charge and discharge the battery.

### Positive Electrode Active Material

Examples of the positive electrode active material that can be contained in the positive electrode layer (1) include at least one selected from the group consisting of a lithium-containing phosphate compound having a NaSICON-type structure, a lithium-containing phosphate compound having an olivine-type structure, a lithium-containing layered oxide, a lithium-containing oxide having a spinel-type structure, and the like. Examples of the lithium-containing phosphate compound having a NaSICON-type structure include Li₃V₂(PO₄)₃. Examples of the lithium-containing phosphate compound having an olivine-type structure include Li₃Fe₂(PO₄)₃, LiFePO₄, LiMnPO₄, and/or LiFe_{0.6}Mn_{0.4}PO₄. Examples of the lithium-containing layered oxide include LiCoO₂, LiCo_{1/3}Ni_{1/3}Mn_{1/3}O₂, and/or LiCo_{0.8}Ni_{0.15}Al_{0.05}O₂. Examples of the lithium-containing oxide having a spinel-type structure include LiMn₂O₄ and/or

Furthermore, examples of the positive electrode active material capable of occluding and releasing sodium ions include at least one selected from the group consisting of a sodium-containing phosphate compound having a NaSICON-type structure, a sodium-containing phosphate compound having an olivine-type structure, a sodium-containing layered oxide, a sodium-containing oxide having a spinel-type structure, and the like.

### Negative Electrode Active Material

Examples of the negative electrode active material that can be contained in the negative electrode layer (2) include at least one selected from the group consisting of an oxide containing at least one element selected from the group consisting of Ti, Si, Sn, Cr, Fe, Nb, and Mo, a carbon material such as graphite, a graphite-lithium compound, a lithium alloy, a lithium-containing phosphate compound having a NaSICON-type structure, a lithium-containing phosphate compound having an olivine-type structure, a lithium-containing oxide having a spinel-type structure, and the like.

Examples of the lithium alloy include Li—Al. Examples of the lithium-containing phosphate compound having a NaSICON-type structure include Li₃V₂ (PO₄)₃ and/or LiTi₂(PO₄)₃. Examples of the lithium-containing phosphate compound having an olivine-type structure include Li₃Fe₂(PO₄)₃ and/or LiCuPO₄. Examples of the lithium-containing oxide having a spinel-type structure include Li₄Ti₅O₁₂.

Furthermore, examples of the negative electrode active material capable of occluding and releasing sodium ions include at least one selected from the group consisting of a sodium-containing phosphate compound having a NaSICON-type structure, a sodium-containing phosphate compound having an olivine-type structure, a sodium-containing oxide having a spinel-type structure, and the like.

Note that, in the solid state battery, the positive electrode layer and the negative electrode layer may be made of the same material.

The positive electrode layer and/or the negative electrode layer may contain a conductive material. Examples of the conductive material that can be contained in the positive electrode layer and the negative electrode layer include at least one selected from the group consisting of metal materials such as silver, palladium, gold, platinum, aluminum, copper, and nickel, and carbon, and the like.

Moreover, the positive electrode layer and/or the negative electrode layer may contain a sintering additive. Examples of the sintering additive include at least one selected from the group consisting of lithium oxide, sodium oxide, potassium oxide, boron oxide, silicon oxide, bismuth oxide, and phosphorus oxide.

Thicknesses of the positive electrode layer and the negative electrode layer are not particularly limited. For example, the thickness of each of the positive electrode layer and the negative electrode layer may be 2 μm to 100 μm, and particularly may be 5 μm to 50 μm.

### Solid Electrolyte

The solid electrolyte (or solid electrolyte layer) (3) is, for example, a material capable of conducting ions such as lithium ions or sodium ions. In particular, the solid electrolyte constituting a battery constituent unit in the solid state battery may form, for example, a layer capable of conducting lithium ions between the positive electrode layer and the negative electrode layer. Specific examples of the solid electrolyte include a lithium-containing phosphate compound having a NaSICON-type structure, an oxide having a perovskite-type structure, an oxide having a garnet-type or garnet-type similar structure, and an oxide glass ceramic-based lithium ion conductor. Examples of the lithium-containing phosphate compound having a NaSICON-type structure include LiₓM_{y}(PO₄)₃ (1≤x≤2, 1≤y≤2, and M is at least one selected from the group consisting of Ti, Ge, Al, Ga, and Zr.). Examples of the lithium-containing phosphate compound having a NaSICON-type structure include Li_{1.2}Al_{0.2}Ti_{1.8}(PO₄)₃. Examples of the oxide having a perovskite-type structure include La_{0.55}Li_{0.35}TiO₃. Examples of the oxide having a garnet-type or garnet-type similar structure include Li₇La₃Zr₂O₁₂.

As the oxide glass ceramic-based lithium ion conductor, for example, a phosphate compound (LATP) containing lithium, aluminum, and titanium as constituent elements, and a phosphate compound (LAGP) containing lithium, aluminum, and germanium as constituent elements can be used.

Furthermore, examples of the solid electrolyte capable of conducting sodium ions include a sodium-containing phosphate compound having a NaSICON-type structure, an oxide having a perovskite-type structure, and an oxide having a garnet-type or garnet-type similar structure. Examples of the sodium-containing phosphate compound having a NaSICON-type structure include NaₓM_{y}(PO₄)₃ (1≤x≤2, 1≤y≤2, and M is at least one selected from the group consisting of Ti, Ge, Al, Ga, and Zr.).

The solid electrolyte layer may contain a sintering additive. The sintering additive that can be contained in the solid electrolyte layer may be selected from, for example, materials similar to the sintering additive that can be contained in the positive electrode layer and/or the negative electrode layer.

A thickness of the solid electrolyte layer is not particularly limited. The thickness of the solid electrolyte layer may be, for example, 1 μm to 15 μm, and particularly 1 μm to 5 μm.

### Positive Electrode Current Collecting Layer and Negative Electrode Current Collecting Layer

The positive electrode layer (1) and the negative electrode layer (2) may each include a positive electrode current collecting layer and a negative electrode current collecting layer. Each of the positive electrode current collecting layer and the negative electrode current collecting layer may have a form of a foil. However, the positive electrode current collecting layer and the negative electrode current collecting layer may have a form of a sintered body from the viewpoint of reducing the manufacturing cost of the solid state battery by integral firing and reducing the internal resistance of the solid state battery. Note that, when the positive electrode current collecting layer and/or the negative electrode current collecting layer have a form of a sintered body, the positive electrode current collecting layer and/or the negative electrode current collecting layer may be formed of a sintered body containing a conductive material and/or a sintering additive. The conductive material that can be contained in the positive electrode current collecting layer and/or the negative electrode current collecting layer may be selected from, for example, materials similar to the conductive material that can be contained in the positive electrode layer and/or the negative electrode layer. The sintering additive that can be contained in the positive electrode current collecting layer and/or the negative electrode current collecting layer may be selected from, for example, a material similar to the sintering additive that can be contained in the positive electrode layer and/or the negative electrode layer.

Thicknesses of the positive electrode current collecting layer and the negative electrode current collecting layer are not particularly limited. For example, the thickness of each of the positive electrode current collecting layer and the negative electrode current collecting layer may be 1 μm to 10 μm, and particularly 1 μm to 5 μm.

Note that, in the solid state battery of the present disclosure, the positive electrode current collecting layer and/or the negative electrode current collecting layer are not essential, and a solid state battery in which such a positive electrode current collecting layer and/or a negative electrode current collecting layer are not provided is also conceivable. That is, the solid state battery in the present invention may be a “current collection-less” solid state battery (see FIG. 2).

### External Terminal

The solid state battery laminate (5) is provided with a terminal for connection with the outside (hereinafter referred to as “external terminal” or “external terminal 6”). In particular, it is preferable that a terminal for connection with the outside is provided as an “end face electrode” on a side surface (specifically, left and right side surfaces) of the solid state battery laminate (5). More specifically, as the external terminal 6, for example, as illustrated in FIG. 2, a terminal (positive electrode terminal) (6A) on a positive electrode side electrically connected to the positive electrode layer (1) and a terminal (negative electrode terminal) (6B) on a negative electrode side electrically connected to the negative electrode layer (2) may be provided in the solid state battery laminate 5. Such a terminal is preferably made of a material having high conductivity (or a conductive material). The material of the terminal is not particularly limited, and examples thereof include at least one selected from the group consisting of gold, silver, platinum, aluminum, tin, nickel, copper, manganese, cobalt, iron, titanium, and chromium.

A position where the terminal is disposed is not particularly limited, and is not limited to the left and right side surfaces of the solid state battery laminate.

[Features of Solid State Battery of Present Disclosure]

The present invention relates to a solid state battery. For example, FIG. 1 illustrates a solid state battery according to an embodiment of the present invention (Hereinafter, the battery may be referred to as a “solid state battery of the present disclosure”.). The solid state battery of the present disclosure includes, for example, as illustrated in FIG. 1, a solid state battery laminate including at least one battery constituent unit along a lamination direction, the battery constituent unit including at least two electrode layers (1, 2) having different polarities and at least a solid electrolyte layer 3 interposed between the electrode layers (1, 2) (see FIG. 2).

The solid state battery of the present disclosure includes an external terminal 6 (a positive electrode terminal or a negative electrode terminal). For example, the solid state battery laminate 5 includes a positive electrode terminal 6A and a negative electrode terminal 6B provided on opposing side surfaces (specifically, left and right side surfaces) as illustrated in FIG. 2.

In the solid state battery of the present disclosure, for example, as illustrated in FIG. 1, the electrode layer (1, 2) may have a configuration in which an active material part (1′, 2′) which may be included in the electrode layer (1, 2) and an insulating part 4 (or a part thereof) are laminated in an up-down direction on each other in a boundary region X with the external terminal 6, and the insulating part 4 covers the active material part (1′, 2′) in a “sleeve shape” in a sectional view.

Hereinafter, for convenience of description, the electrode layer 1 is illustrated as a positive electrode layer and the electrode layer 2 is illustrated as a negative electrode layer in FIG. 1, but the electrode layer 1 may be a negative electrode layer, and thus the electrode layer 2 may be a positive electrode layer. That is, the external terminal 6 is illustrated as a positive electrode terminal for convenience of description, but the external terminal 6 may be a positive electrode terminal or a negative electrode terminal.

Hereinafter, features of the present invention will be described more specifically after describing each term.

### Active Material Part

In the present disclosure, the “active material part” means a part containing an electrode active material in the electrode layer. More specifically, it means a part including at least the “positive electrode active material” in the positive electrode layer and a part including at least the “negative electrode active material” in the negative electrode layer.

### Boundary Region

In the present disclosure, a “boundary region” means a region where the “electrode layer” and the “external terminal” can be disposed to face each other, and in this boundary region, the “electrode layer” and the “external terminal” may or may not be electrically connected to each other.

In the solid state battery of the present disclosure, the “insulating part” can be disposed in such a boundary region. Therefore, in the solid state battery of the present disclosure, a region where such an “insulating part” can be disposed can also be referred to as a “boundary region”.

More specifically, as illustrated in FIG. 1, the boundary region X exists in a region where the electrode layer 1 (for example, the positive electrode layer) and the external terminal 6 (for example, the positive electrode terminal) can be disposed to face each other, and a region where the electrode layer 2 (for example, the negative electrode layer) and the external terminal 6 (for example, the positive electrode terminal) can be disposed to face each other.

For example, in the aspect illustrated in FIG. 1, the electrode layer 1 and the external terminal 6 are electrically connected, and the electrode layer 2 and the external terminal 6 are not electrically connected via the insulating part 4.

### Insulating Part

In the present disclosure, the “insulating part” (also referred to as a “electrode separation part” or a “margin part” or “margin layer”) means a part where at least the electrode layer (positive electrode layer and/or negative electrode layer) and the external terminal can face each other, that is, the electrode layer can be disposed in a boundary region between the electrode layer and the external terminal, and the electrode layer and the external terminal can be separated from each other and/or electrically insulated from each other. Specifically, it means a part that separates the electrode layer and the external terminal from each other and/or electrically insulates the electrode layer and the external terminal from each other in a direction in which the positive electrode terminal and the negative electrode terminal of the solid state battery face each other or in a left-right direction.

A material that can form the insulating part is not particularly limited, but for example, the insulating part is preferably formed of the above-described “solid electrolyte” or “insulating material”.

Examples of the “insulating material” include a glass material and a ceramic material.

The “glass material” is not particularly limited, and examples thereof include at least one selected from the group consisting of soda lime glass, potash glass, borate-based glass, borosilicate-based glass, barium borosilicate-based glass, borosilicate-based glass, barium borate-based glass, bismuth silicate-based glass, bismuth zinc borate glass, bismuth silicate-based glass, phosphate-based glass, aluminophosphate-based glass, and phosphite-based glass.

The “ceramic material” is not particularly limited, and examples thereof include at least one selected from the group consisting of aluminum oxide (Al₂O₃), boron nitride (BN), silicon dioxide (SiO₂), silicon nitride (Si₃N₄), zirconium oxide (ZrO₂), aluminum nitride (AlN), silicon carbide (SiC), and barium titanate (BaTiO₃).

When the material that can constitute the insulating part includes a solid electrolyte, the solid electrolyte material that can be included in the insulating part is preferably the same material as the solid electrolyte that can be included in the “solid electrolyte layer”. With such a configuration, the bonding property between the insulating part and the solid electrolyte layer can be further improved.

### “Sleeve-Shaped” Part

For example, as illustrated in FIG. 1, the solid state battery of the present disclosure is mainly characterized in that at least one of two electrode layers (specifically, the positive electrode layer 1 and the negative electrode layer 2) has a configuration in which an active material part (1′, 2′) included in the electrode layers (1, 2) and the insulating part 4 (or a part thereof) are laminated in the up-down direction on each other in a boundary region X with the external terminal 6 (specifically, the positive electrode terminal), and the insulating part 4 covers the active material part (1′, 2′) in a “sleeve shape” in a sectional view. In other words, the electrode layer covered with the sleeve-shaped part of the insulating part in the sectional view is the active material part.

For example, in the aspect illustrated in FIG. 1, the “sleeve-shaped” part of the insulating part 4 is denoted by reference sign “S” (Sleeve), and other “non-sleeve-shaped” parts are denoted by reference sign “NS” (Non-Sleeve).

In the boundary region X illustrated in FIG. 1, it is preferable that the sleeve-shaped part (S) of the insulating part 4 is provided so as to sandwich the active material part (1′, 2′) from above and below in the lamination direction in sectional view. In other words, it is preferable that the sleeve-shaped part (S) of the insulating part 4 is disposed so as to sandwich the active material part (1′, 2′) of the electrode layer (1, 2) from the up-down direction. More easily understood, the sleeve-shaped part (S) of the insulating part 4 preferably has, for example, a shape such as an arm of a robot, a claw of a crab, or a lip in a sectional view.

In the aspect illustrated in FIG. 1, the sleeve-shaped part (S) is illustrated in a rectangular or rectangular shape in a sectional view, but a boundary between the sleeve-shaped part (S) and the active material part (1′, 2′) may be a gentle curve, may be curved inward, may be curved outward, may be a fillet shape, or may be a shape that tapers and narrows toward the external terminal 6.

By forming the “sleeve-shaped” part (S) in this manner, it is possible to suppress the extension (exudation, protrusion) of the active material part (1′, 2′) of the electrode layer (1, 2) in the up-down direction (or the lamination direction), particularly, the proximity to the electrode layers having different polarities particularly at the time of manufacturing the solid state battery laminate, and it is possible to further prevent a short circuit between the electrode layers facing each other in the lamination direction after manufacturing.

Furthermore, by forming the “sleeve-shaped” part (S) in this manner, particularly at the time of manufacturing the solid state battery laminate, it is possible to further suppress the extension (exudation, protrusion) of the active material part 2′ of the electrode layer 2 in the left-right direction (or the direction in which the positive electrode terminal and the negative electrode terminal face each other), particularly the proximity to the external terminal 6, and it is possible to further prevent the short circuit of the electrode layer 2 with the external terminal 6 facing each other after manufacturing.

By forming the “sleeve-shaped” part (S) in this manner, a contact area of the insulating part 4 with the solid electrolyte layer 3 can be further secured, and delamination at the interface of the electrode layer (1, 2), specifically, delamination from the solid electrolyte layer, particularly interlayer delamination, can be further suppressed during manufacturing of the solid state battery or during charging and discharging of the solid state battery.

Here, as illustrated in FIG. 1, in the sectional view, a ratio (ratio of length/thickness) of a length (specifically, a dimension in the left-right direction thereof) of the sleeve-shaped part (S) of the insulating part 4 to a thickness (specifically, a dimension in the lamination direction (up-down direction)) of the electrode layer (1, 2) is, for example, 0.05% to 10%.

Furthermore, as illustrated in FIG. 1, it is preferable that a part (S) where the active material part 1′ of the electrode layer 1 (specifically, the positive electrode layer 1) is covered in a sleeve shape by the insulating part 4 and a part (S) where the active material part 2′ of the electrode layer 2 (specifically, the negative electrode layer 2) is covered in a sleeve shape by the insulating part 4 overlap each other in the lamination direction (up-down direction) (for example, a part indicated by a distance D₁ in FIG. 1).

By forming such an overlapping part, it is possible to further prevent a short circuit or interlayer delamination between the electrode layers facing each other in the lamination direction.

A length of the part where the sleeve-shaped parts (S) of the insulating part 4 overlap is, for example, 10 μm to 200 μm, and preferably 30 μm to 50 μm as a length in the direction (left-right direction) in which the positive electrode terminal and the negative electrode terminal face each other, which is indicated by a distance D₁ in the sectional view of FIG. 1.

A thickness (T_{S}) of the sleeve-shaped part (S) of the insulating part 4 is, for example, 1% to 50% (T_{S}/T₃×100 (%)) with respect to a thickness (T₃) of the solid electrolyte layer 3. Note that, since the sleeve-shaped part (S) may have a sectional shape other than a rectangular shape, the thickness (T_{S}) may be a value obtained by dividing the area (specifically, the area of the section is) of the sleeve-shaped part (S) by the length (specifically, the dimension in the left-right direction thereof) of the sleeve-shaped part (S) as an “average thickness”.

The thickness (T_{S}) of the sleeve-shaped part (S) of the insulating part 4 can be determined by, for example, measuring from a photograph such as a scanning electron microscope (SEM).

In the illustrated aspect, the thicknesses (T_{S}) of the sleeve-shaped parts (S) of the insulating part 4 may be different from or the same as each other.

In the “non-sleeve-shaped” part (NS) of the insulating part 4, for example, as illustrated by the electrode layer 1 (specifically, the positive electrode layer 1), the active material part 1′ may extend to the external terminal 6 (specifically, the positive electrode terminal), and the electrode layer 1 may be electrically connected to the external terminal 6. That is, an electrical “connected state” may be formed.

Furthermore, in the “non-sleeve-shaped” part (NS) of the insulating part 4, for example, as illustrated by the electrode layer 2 (specifically, the negative electrode layer 2), the active material part 2′ may not extend to the external terminal 6 (specifically, the positive electrode terminal), and the electrode layer 2 may not be electrically connected to the external terminal 6. That is, the electrical “disconnected state” may be formed by the insulating part 4.

Since the insulating part 4 has the “non-sleeve-shaped” part (NS) as described above, electrical connection with the external terminal of the electrode layer can be arbitrarily selected.

Hereinafter, the present invention will be described in detail with reference to preferred embodiments.

### First Embodiment

As a solid state battery according to a preferred embodiment of the present invention, for example, a solid state battery 10 of the first embodiment is illustrated in FIG. 2.

The solid state battery 10 illustrated in FIG. 2 includes a solid state battery laminate 5 including at least one battery constituent unit along a lamination direction, the battery constituent unit including a positive electrode layer 1, a negative electrode layer 2, and a solid electrolyte layer 3 interposed at least between the positive electrode layer 1 and the negative electrode layer 2.

The solid state battery 10 includes external terminals of a positive electrode terminal 6A and a negative electrode terminal 6B respectively provided on opposing side surfaces (specifically, left and right side surfaces) of the solid state battery laminate 5.

In the solid state battery 10, at least one electrode layer of the positive electrode layer 1 and the negative electrode layer 2 has a configuration in which an active material part (1′, 2′) of the electrode layer (1, 2) and an insulating part (or a part thereof) are laminated in the up-down direction with each other in a boundary region (Xₐ, X_{b}) with an external terminal (6A, 6B), and the insulating part covers the active material part (1′, 2′) in a sleeve shape in a sectional view.

In the positive electrode layer 1, an insulating part 4a on the positive electrode side exists in the boundary region Xₐ with the positive electrode terminal 6A. The positive electrode layer 1 (or the active material part 1′) is electrically connected to the positive electrode terminal 6A. More specifically, the positive electrode layer 1 extends inside (inside) the insulating part 4a and is electrically connected to the positive electrode terminal 6A (formation of a connected state).

In the positive electrode layer 1, an insulating part 4b on the negative electrode side is also present in the boundary region X_{b} between the positive electrode layer 1 and the negative electrode terminal 6B, and the positive electrode layer 1 is not electrically connected to the negative electrode terminal 6B (formation of a non-connected state).

Note that, as the insulating part 4a on the positive electrode side and the insulating part 4b on the negative electrode side which can be disposed in the positive electrode layer 1, the same insulating part as the insulating part 4 (upper stage, lower stage) illustrated in FIG. 1 can be used.

In the negative electrode layer 2, the negative electrode layer 2 is electrically connected to the negative electrode terminal 6B in the boundary region X_{b} with the negative electrode terminal 6B.

In the negative electrode layer 2, the insulating part 4 on the positive electrode side exists in the boundary region Xₐ between the negative electrode layer 2 and the positive electrode terminal 6A, and the active material part 2′ of the negative electrode layer 2 is not electrically connected to the positive electrode terminal 6A (formation of a non-connected state).

As the insulating part 4 on the positive electrode side that can be disposed in the negative electrode layer 2, the same insulating part as the insulating part 4 (lower stage) illustrated in FIG. 1 can be used.

Note that, also in the boundary region X_{b} between the negative electrode layer 2 and the negative electrode terminal 6B, similarly to the insulating part 4a on the positive electrode side, an insulating part on the negative electrode side may be provided. At this time, the negative electrode layer 2 may extend through the inside (inner side) of an insulating part (not illustrated) on the negative electrode side to be electrically connected to the negative electrode terminal 6B (formation of a connected state).

As illustrated in FIG. 2, in the solid state battery 10, a sleeve-shaped part of the insulating part and the electrode layer (or a part where the active material part is not covered with the insulating part) are preferably flush with each other in a sectional view.

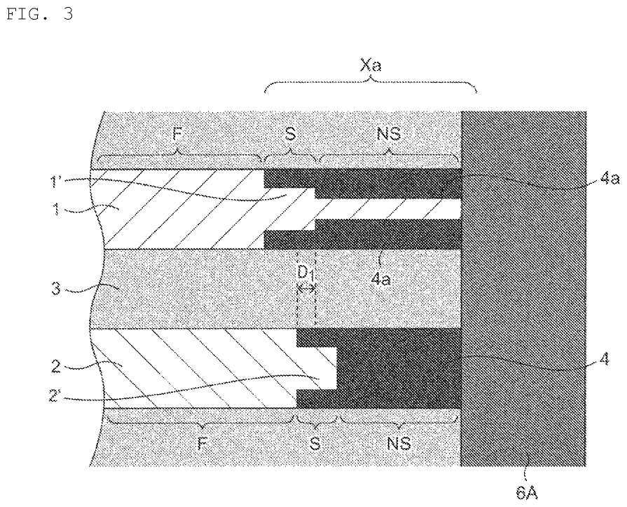

More specifically, as illustrated in an enlarged view in FIG. 3, in the positive electrode layer 1, the sleeve-shaped part (S) of the insulating part 4a and the positive electrode layer 1 (specifically, the part (F) where the active material part 1′ of the positive electrode layer 1 is not covered with the insulating part 4a) are preferably flush with each other.

Similarly, in the negative electrode layer 2, the sleeve-shaped part (S) of the insulating part 4 and the negative electrode layer 2 (specifically, the part (F) where the active material part 2′ of the negative electrode layer 2 is not covered with the insulating part 4) are preferably flush with each other.

Therefore, in the aspect illustrated in FIG. 3, since the thicknesses of the layers can be made uniform, the structural stability of the solid state battery is further improved. Furthermore, when the thicknesses of the layers are equal to each other, interlayer delamination at the interface between the electrode layer and the solid electrolyte layer can be further suppressed.

In the aspect illustrated in FIG. 3, in the sectional view, the ratio (ratio of length/thickness) of the length (specifically, the dimension in the left-right direction thereof) of the sleeve-shaped part (S) of the insulating part 4 to the thickness (specifically, the dimension in the lamination direction (up-down direction)) of the electrode layers (1, 2) is, for example, 0.05% to 10%.

Furthermore, it is preferable that the sleeve-shaped part (S) of the insulating part 4a of the positive electrode layer 1 and the sleeve-shaped part (S) of the insulating part 4 of the negative electrode layer 2 overlap each other in the lamination direction (up-down direction). A distance D₁ of the overlapping part is, for example, 10 μm to 200 μm, preferably 30 μm to 50 μm as a length in a direction (left-right direction) in which the positive electrode terminal and the negative electrode terminal of the solid state battery 10 face each other.

In the solid state battery 10, a total length of the sleeve-shaped part (S) and the non-sleeve-shaped part (NS) is not particularly limited, and for example, as illustrated in FIG. 3, the positive electrode layer 1 may be longer, and the negative electrode layer 2 may be longer. For example, as illustrated in FIG. 1, the insulating part may have the same length between the positive electrode layer 1 and the negative electrode layer 2.

With such a configuration, it is possible to further suppress an electrical short circuit (that is, a short circuit in the up-down direction) between the electrode layers (1, 2), an electrical short circuit between the negative electrode layer 2 and the positive electrode terminal 6A, an electrical short circuit between the positive electrode layer 1 and the negative electrode terminal 6B (that is, a short circuit in the left-right direction), interlayer delamination between the electrode layers (1, 2) and the solid electrolyte layer 3, and the like.

### Second Embodiment

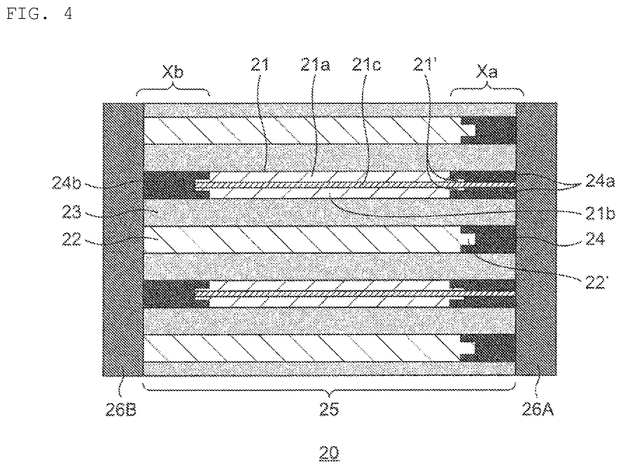

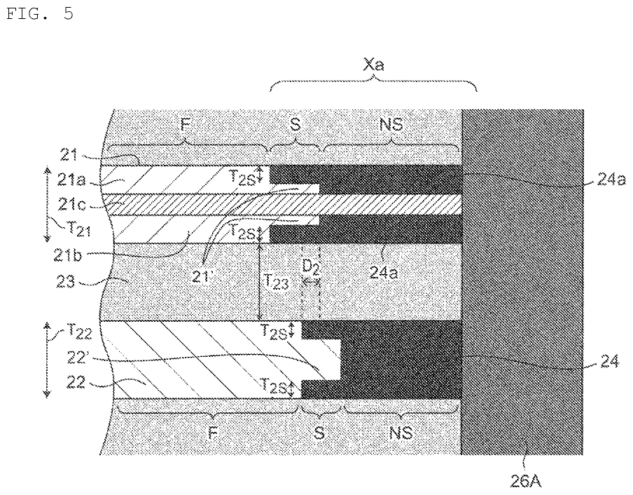

As a solid state battery according to a preferred embodiment of the present invention, a solid state battery 20 of a second embodiment is illustrated in FIGS. 4 and 5.

The configuration of the solid state battery 20 of the second embodiment is the same as the configuration of the solid state battery 10 of the first embodiment, but the solid state battery 20 of the second embodiment is different from the solid state battery 10 in that a positive electrode layer 21 includes a positive electrode current collecting layer 21c.

In the positive electrode layer 21, the positive electrode current collecting layer 21c extends so as to pass between sleeve-shaped insulating parts 24a in sectional view, and is electrically connected to a positive electrode terminal 26A particularly through a non-sleeve-shaped part (NS) of the insulating parts 24a (FIG. 5).

In the solid state battery 20, similarly to the positive electrode layer 21, a negative electrode layer 22 may also include a negative electrode current collecting layer (not illustrated).

In the aspect illustrated in FIG. 5, in the sectional view, a ratio (ratio of length/thickness) of a length (specifically, the dimension in the left-right direction thereof) of the sleeve-shaped part (S) to a thickness (specifically, the dimension in the lamination direction (up-down direction)) of the electrode layer (21, 22) is, for example, 0.05% to 10%.

Furthermore, for example, as illustrated in FIG. 5, it is preferable that the sleeve-shaped part (S) of the insulating part 24a of the positive electrode layer 21 and the sleeve-shaped part (S) of an insulating part 24 of the negative electrode layer 22 overlap each other in the lamination direction (up-down direction). A distance D₂ of the overlapping part is, for example, 10 μpm to 200 μm, preferably 30 μm to 50 μm as a length in a direction (left-right direction) in which a positive electrode terminal and a negative electrode terminal face each other.

In the solid state battery 20 according to the second embodiment, since the insulating parts 24a and 24b of the positive electrode layer 21 and the insulating part 24 of the negative electrode layer 22 can have the same configuration as the insulating part (4a, 4b, 4) of the solid state battery 10 according to the first embodiment (FIGS. 2 and 4), when the electrode layers (21, 22) include a current collecting layer, that is, when the electrode layers are multilayered, an electrical short circuit between the electrode layers (21, 22) (that is, a short circuit in the up-down direction), an electrical short circuit between the negative electrode layer 22 and the positive electrode terminal 26A, an electrical short circuit between the positive electrode layer 21 and the negative electrode terminal 26B (that is, a short circuit in the left-right direction), interlayer delamination between the electrode layers (21, 22) and the solid electrolyte layer 23, and the like can be similarly suppressed.

### Third Embodiment

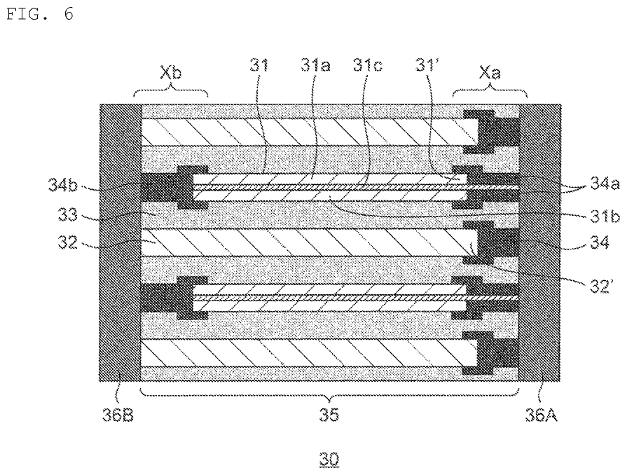

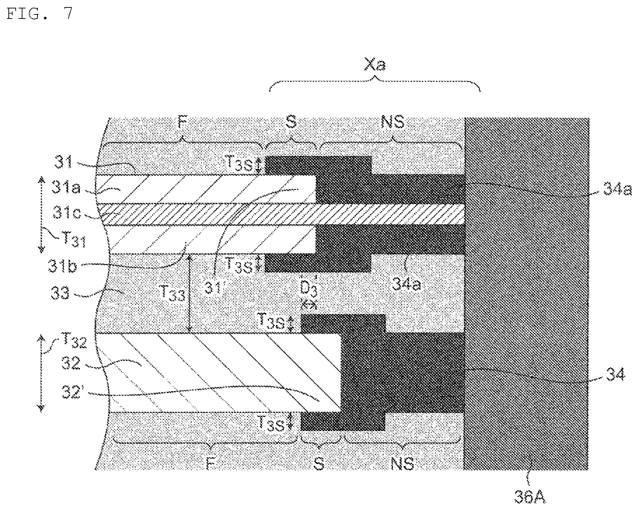

FIGS. 6 and 7 illustrate a solid state battery 30 of a third embodiment as a solid state battery according to a preferred embodiment of the present invention.

The configuration of the solid state battery 30 of the third embodiment is the same as the configuration of the solid state battery 20 of the second embodiment, but the solid state battery 30 of the third embodiment is different from the solid state battery 20 in that the shapes of insulating parts 34a and 34b of a positive electrode layer 31 and an insulating part 34 of a negative electrode layer 32 are changed.

In the solid state battery 30, in a sectional view, a sleeve-shaped part of the insulating part rises or swells, or is higher than a part where the electrode layer (or the active material part) is not covered with the insulating part.

More specifically, as illustrated in an enlarged view in FIG. 7, a sleeve-shaped part (S) of the insulating part 34a of the positive electrode layer 31 rises or swells, or is higher than a part (F) where the positive electrode layer 31 (or an active material part (31′)) is not covered with the insulating part 34a. More specifically, the sleeve-shaped part (S) rises or swells in the up-down direction in the lamination direction.

A sleeve-shaped part (S) of the insulating part 34 of the negative electrode layer 32 rises or swells, or is higher than a part (F) where the negative electrode layer 32 (or an active material part (32′)) is not covered with the insulating part 34. More specifically, the sleeve-shaped part (S) rises or swells in the up-down direction in the lamination direction.

Note that, in the illustrated embodiment, the sleeve-shaped part (S) is illustrated as being raised in a rectangular shape due to a step in a sectional view, but may be raised, swelled, or higher by drawing an arc with a gentle curve or a curved surface.

A thickness (T_{3S}) of the sleeve-shaped part (S) is raised at a height in a range of, for example, 1% to 50% with respect to a thickness (131, 132) of the part (F) of the electrode layer, which is not covered with the insulating part (T_{3S}/T₃₁ or T₃₂×100 (%)).

The thickness (T_{3S}) of the sleeve-shaped part (S) is raised or swelled or increased to a height in a range of, for example, 1% to 50% with respect to a thickness (133) of the solid electrolyte layer 33 (T_{3S}/T₃₃×100 (%)).

In the illustrated aspect, the thicknesses (T_{3S}) of the sleeve-shaped parts (S) may be different from each other or may be the same.

In the solid state battery 30, in a sectional view, a raised sleeve-shaped part of the insulating part is preferably raised, swelled, or higher than a part of the insulating part in contact with the external terminal.

More specifically, as illustrated in FIG. 7, in the sectional view, it is preferable that the raised sleeve-shaped part (S) of the insulating part 34a of the positive electrode layer 31 is raised more than the part of the insulating part 34a in contact with a positive electrode terminal 36A (specifically, an end part of the non-sleeve-shaped part (NS) in contact with the positive electrode terminal 36A on the right side).

Furthermore, in the sectional view, the raised sleeve-shaped part (S) of the insulating part 34 of the negative electrode layer 32 is preferably raised, swelled, or higher than a part of the insulating part 34 in contact with the positive electrode terminal 36A (specifically, the end part of the non-sleeve-shaped part (NS) in contact with the positive electrode terminal 36A on the right side).

In the aspect illustrated in FIG. 7, in the sectional view, a ratio (ratio of length/thickness) of a length (specifically, a dimension in the left-right direction thereof) of the sleeve-shaped part (S) to a thickness (specifically, a dimension in the lamination direction (up-down direction) (T₃₁, T₃₂)) of the electrode layer (31, 32) is, for example, 0.05% to 10%.

Furthermore, it is preferable that the sleeve-shaped part (S) of the insulating part 34a of the positive electrode layer 31 and the sleeve-shaped part (S) of the insulating part 34 of the negative electrode layer 32 overlap each other in the lamination direction (up-down direction). A distance D₃ of the overlapping part is, for example, 10 μm to 200 μm, preferably 30 μm to 50 μm as a length in a direction (left-right direction) in which the positive electrode terminal and the negative electrode terminal face each other.

In the solid state battery 30 of the third embodiment, the sleeve-shaped part (S) is raised, so that an electrical short circuit (that is, a short circuit in the up-down direction) between the electrode layers (31, 32), an electrical short circuit between the negative electrode layer 32 and the positive electrode terminal 36A, an electrical short circuit between the positive electrode layer 31 and the negative electrode terminal 36B (that is, a short circuit in the left-right direction), interlayer delamination between the electrode layers (31, 32) and the solid electrolyte layer 33, and the like can be further suppressed.

Furthermore, in the solid state battery 30 of the third embodiment, as compared with the solid batteries of the first and second embodiments, since the sleeve-shaped part (S) is raised, a filling amount of the active material in each electrode layer can be further increased, so that the energy density can be further improved.

Note that, in the solid state battery 30 of the third embodiment, a lower side (lower surface) of the insulating part may be flush with the part (F) of the electrode layer, which is not covered in a sleeve shape, similarly to the first and second exemplary embodiments (See FIGS. 1 to 5.).

### Fourth Embodiment

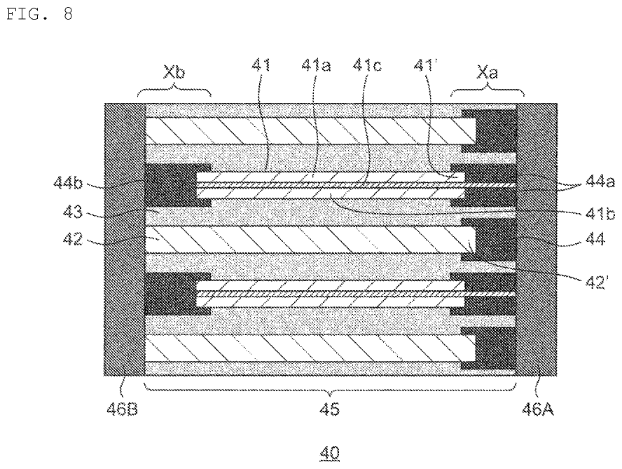

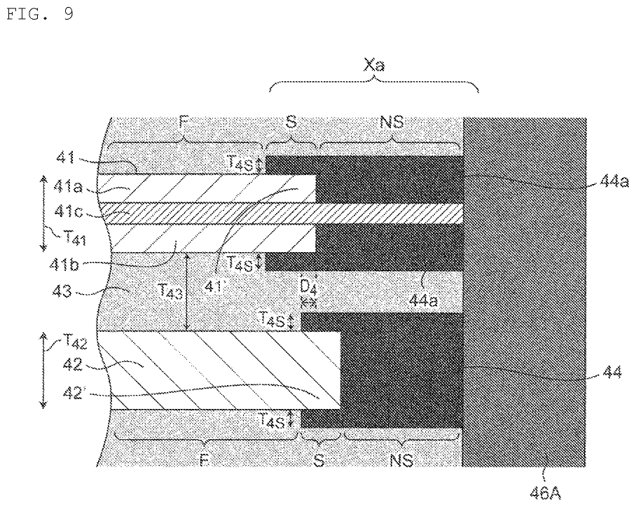

FIGS. 8 and 9 illustrate a solid state battery 40 according to a fourth embodiment as a solid state battery according to a preferred embodiment of the present invention.

The configuration of the solid state battery 40 of the fourth embodiment is the same as the configuration of the solid state battery 30 of the third embodiment, but the solid state battery 40 of the fourth embodiment is different from the solid state battery 30 in that the shapes of insulating parts 44a and 44b of a positive electrode layer 41 and an insulating part 44 of a negative electrode layer 42, particularly the shape of a “non-sleeve-shaped part” are changed.

In the solid state battery 40, in a sectional view, a sleeve-shaped part of the insulating part is raised or swelled, or higher than a part where the electrode layer (or the active material part) is not covered with the insulating part.

More specifically, as illustrated in an enlarged view in FIG. 9, a sleeve-shaped part (S) of the insulating part 44a of the positive electrode layer 41 is raised or swelled, or higher than a part (F) where the positive electrode layer 41 (or the active material part (41′)) is not covered with the insulating part 44a.

A sleeve-shaped part (S) of the insulating part 44 of the negative electrode layer 42 is raised more than a part (F) where the negative electrode layer 42 (or the active material part (42′)) is not covered with the insulating part 44.

Note that, in the illustrated embodiment, the sleeve-shaped part (S) is illustrated as being raised in a rectangular shape due to a step in a sectional view, but may be raised by drawing an arc with a gentle curve or a curved surface.

A thickness (T_{4S}) of the sleeve-shaped part (S) is raised, swelled, or increased to a height in a range of, for example, 1% to 50% with respect to a thickness (141, 142) of the part (F) of the electrode layer, which is not covered with the insulating part (T_{4S}/T₄₁ or T₄₂×100 (%)).

The thickness (T_{4S}) of the sleeve-shaped part (S) is raised or swelled, or increased to a height in a range of, for example, 1% to 50% with respect to a thickness (143) of a solid electrolyte layer 43 (T_{4S}/T₄₃×100 (%)).

In the illustrated aspect, the thicknesses (T_{4S}) of the sleeve-shaped parts (S) may be different from each other or may be the same.

In the solid state battery 40, it is preferable that the raised sleeve-shaped part of the insulating part is flush with the part where the insulating part is in contact with the external terminal in a sectional view.

More specifically, as illustrated in an enlarged view in FIG. 9, in a sectional view, it is preferable that the raised sleeve-shaped part (S) of the insulating part 44a of the positive electrode layer 41 is flush with a part of the insulating part 44a in contact with the positive electrode terminal 46A (specifically, an end part of the non-sleeve-shaped part (NS) in contact with a positive electrode terminal 46A on the right side), or the heights thereof coincide with each other.

Furthermore, in the sectional view, it is preferable that the raised sleeve-shaped part (S) of the insulating part 44 of the negative electrode layer 42 is flush with the part of the insulating part 44 in contact with the positive electrode terminal 46A (specifically, the end part of the non-sleeve-shaped part (NS) in contact with the positive electrode terminal 46A on the right side), or the heights thereof coincide with each other.

In the aspect illustrated in FIG. 9, in the sectional view, a ratio (ratio of length/thickness) of a length (specifically, a dimension in the left-right direction thereof) of the sleeve-shaped part (S) to a thickness (specifically, a dimension in the lamination direction (up-down direction) (T₄₁, T₄₂)) of the electrode layers (41, 42) is, for example, 0.05% to 10%.

Furthermore, it is preferable that the sleeve-shaped part (S) of the insulating part 44a of the positive electrode layer 41 and the sleeve-shaped part (S) of the insulating part 44 of the negative electrode layer 42 overlap each other in the lamination direction (that is, the up-down direction). At distance D₄ of the overlapping part is, for example, 10 μm to 200 μm, or 30 μm to 50 μm as the length in the direction in which the positive electrode terminal and the negative electrode terminal face each other or in the left-right direction.

In the solid state battery 40 of the fourth embodiment, the sleeve-shaped part (S) is raised or swelled, or higher, so that it is possible to further suppress an electrical short circuit (that is, a short circuit in the up-down direction) between the electrode layers (41, 42), an electrical short circuit between the negative electrode layer 42 and the positive electrode terminal 46A, an electrical short circuit between the positive electrode layer 41 and the negative electrode terminal 46B (that is, a short circuit in the left-right direction), interlayer delamination between the electrode layers (41, 42) and the solid electrolyte layer 43, and the like.

In the solid state battery 40 of the fourth embodiment, since the thickness of the non-sleeve-shaped part (NS) of the insulating part is increased as compared with the solid state batteries of the first to third embodiments, an electrical short circuit between the negative electrode layer 42 and the positive electrode terminal 46A and an electrical short circuit between the positive electrode layer 41 and the negative electrode terminal 46B (that is, a short circuit in the left-right direction) can be further suppressed.

Note that, in the solid state battery 40 of the fourth embodiment, the lower side (lower surface) of the insulating part may be flush with the part (F) of each electrode layer not covered with the sleeve-shaped part as in the first and second embodiments (See FIGS. 1 to 5).

In the solid state battery of the present disclosure, the configurations of the first to fourth embodiments may be combined as necessary, and in particular, the insulating parts used in the first to fourth embodiments may be appropriately combined and used.

The solid state battery of the present disclosure is not limited to the above embodiments.

### Method of Manufacturing Solid State Battery

Hereinafter, a method of manufacturing the solid state battery of the present disclosure will be briefly described.

### Formation of Solid State Battery Laminate

The solid state battery laminate can be manufactured by a printing method such as a screen printing method, a green sheet method using a green sheet, or a composite method thereof. That is, the solid state battery laminate itself may be manufactured according to a conventional solid state battery manufacturing method (Therefore, as raw material substances such as a solid electrolyte, an organic binder, a solvent, an optional additive, a positive electrode active material, and a negative electrode active material described below, those used in the manufacturing of known solid state batteries may be used.).

Hereinafter, for better understanding of the present invention, one manufacturing method will be exemplified and described, but the present invention is not limited thereto. Furthermore, temporal matters such as the following description order are merely for convenience of description, and are not necessarily limited thereto.

Note that the formation of the insulating part, which is a characteristic part of the present invention, will be specifically and separately described below.

### Laminate Block Formation

A solid electrolyte, an organic binder, a solvent, an optional additive, and the like are mixed to prepare a slurry. Subsequently, a sheet having a thickness of about 10 μm after firing is obtained from the prepared slurry by sheet forming.

A positive electrode active material, a solid electrolyte, a conductive material, an organic binder, a solvent, an optional additive, and the like are mixed to prepare a positive electrode paste. Similarly, a negative electrode active material, a solid electrolyte, a conductive material, an organic binder, a solvent, an optional additive, and the like are mixed to prepare a negative electrode paste.

The positive electrode paste is printed on the sheet, and a current collecting layer is printed as necessary. Similarly, the negative electrode paste is printed on the sheet, and a current collecting layer is printed as necessary.

The sheet on which the positive electrode paste is printed and the sheet on which the negative electrode paste is printed are alternately laminated to obtain a laminate. Note that, as for an outermost layer (uppermost layer and/or lowermost layer) of the laminate, it may be an electrolyte layer, an insulating layer (Electrically impermeable layers, for example layers that may be composed of non-conductive materials such as glass materials and/or ceramic materials.), or an electrode layer.

### Formation of Battery Sintered Body

After the laminate is pressure-bonded and integrated, the laminate is cut into a predetermined size. The resulting cut laminate is subjected to degreasing and firing. Thus, a sintered laminate is obtained. Note that the laminate may be subjected to degreasing and firing before cutting, and then cut.

### Formation of External Terminal

The external terminal (or end face electrode) on the positive electrode side can be formed by applying a conductive paste to the positive electrode exposed side surface of the sintered laminate. Similarly, the external terminal (or end face electrode) on the negative electrode side can be formed by applying the conductive paste to the negative electrode exposed side surface of the sintered laminate.

Note that the external terminals on the positive electrode side and the negative electrode side are not limited to be formed after sintering of the laminate, and may be formed before firing and subjected to simultaneous sintering.

### Formation of Insulating Part

The insulating part can be formed, for example, as follows as necessary in the “laminate block formation” (before firing) described above.

A solid electrolyte and/or an insulating material, a binder, an organic binder, a solvent, an optional additive, and the like are mixed to prepare an insulating paste (or also referred to as an electrode separation paste or a margin paste).

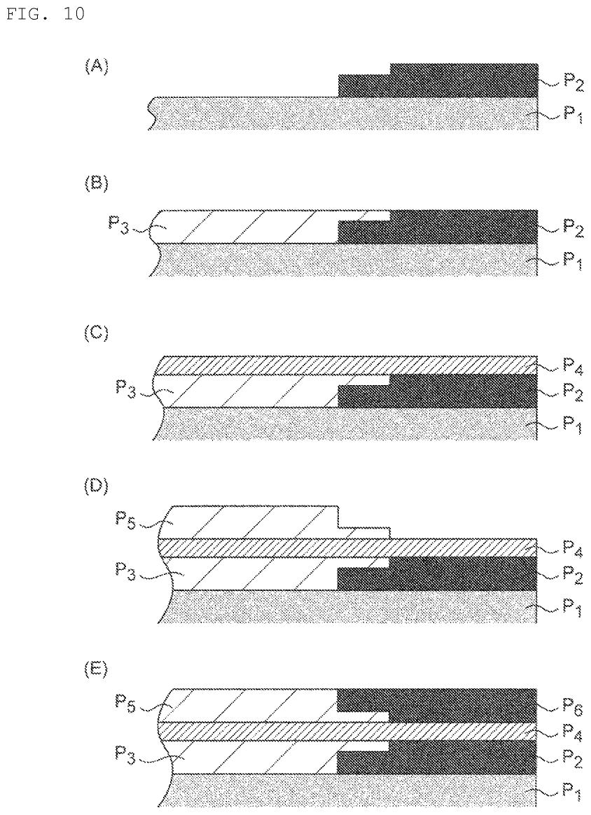

For example, the insulating part 24a having the shape illustrated in FIG. 5 (upper stage) can be formed according to, for example, a procedure illustrated in FIG. 10.

(A)

An insulating paste P₂ is printed on a sheet P₁ formed of the slurry containing the solid electrolyte. At this time, it is preferable to print the insulating paste P₂ so that a desired “sleeve-shaped” part is formed.

(B)

An electrode paste (positive electrode paste or negative electrode paste) P₃ is printed on a part of the sheet P₁ and the paste P₂ (a part that becomes a “sleeve-shaped” part).

(C)

A current collecting layer (paste) P₄ is printed on a whole surface of the paste P₂ and the paste P₃ as necessary.

(D)

An electrode paste Ps is printed on the current collecting layer P₄ (the electrode paste P₅ has the same polarity as the electrode paste P₃). At this time, it is preferable to print the electrode paste Ps so that a desired “sleeve-shaped” part can be formed.

(E)

An insulating paste P₆ is printed on a part of the current collecting layer P₄ and the paste Ps (a part covered with a “sleeve-shaped” part). Here, the paste P₆ is preferably the same as the paste P₂.

In this way, for example, the insulating part having the shape illustrated in FIG. 5 (upper stage) can be finally formed by firing, but the formation of the insulating part is not limited by the above method.

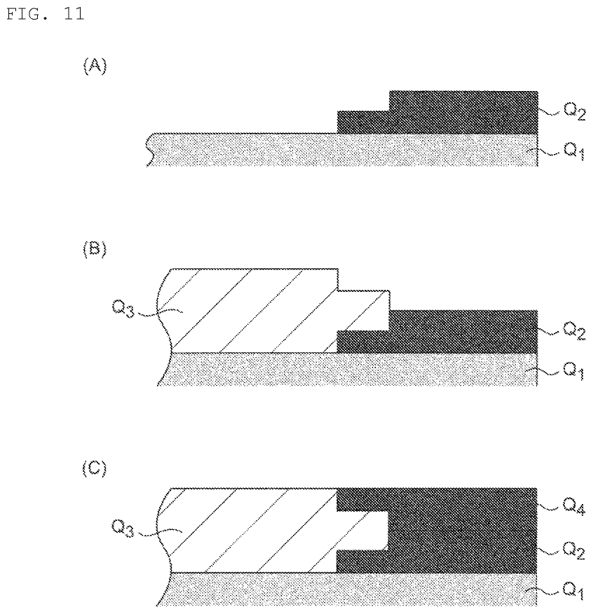

For example, the insulating part 24 or the like having the shape illustrated in FIG. 5 (lower stage) can be formed according to, for example, a procedure illustrated in FIG. 11 or the like.

(A)

An insulating paste Q₂ is printed on a sheet Q₁ formed of the slurry containing the solid electrolyte. At this time, it is preferable to print an insulating paste so that a desired “sleeve-shaped” part can be formed.

(B)

An electrode paste (positive electrode paste or negative electrode paste) Q₃ is printed on a part of the sheet Q₁ and the paste Q₂ (a part that becomes a “sleeve-shaped” part).

(C)

An insulating paste Q₄ is printed on a part of the paste Q₂ and the paste Q₃ (a part covered with a “sleeve-shaped” part). Here, the paste Q₄ is preferably the same as the paste Q₂.

In this way, for example, the insulating part having the shape illustrated in FIG. 5 (lower stage) can be finally formed by firing. However, the formation of the insulating part is not limited to the above method.

Various variations of the insulating part can be formed by forming the insulating part according to the above-described procedure.

Through the above steps, a desired solid state battery can be finally obtained, but the method of manufacturing a solid state battery is not limited to the above manufacturing method.

The solid state battery of the present invention can be used in various fields where battery use or power storage can be assumed. Although it is merely an example, the solid state battery of the present invention can be used in the fields of electricity, information, and communication (for example, electric and electronic equipment fields or mobile equipment fields including mobile phones, smartphones, notebook computers and digital cameras, activity meters, arm computers, electronic paper, wearable devices, RFID tags, card-type electronic money, small electronic machines such as smartwatches, and the like.) in which electricity, electronic equipment, and the like can be used, home and small industrial applications (for example, the fields of electric tools, golf carts, and home, nursing, and industrial robots), large industrial applications (for example, fields of forklift, elevator, and harbor crane), transportation system fields (field of, for example, hybrid automobiles, electric automobiles, buses, trains, power-assisted bicycles, and electric two-wheeled vehicles), power system applications (for example, fields such as various types of power generation, road conditioners, smart grids, and household power storage systems), medical applications (medical equipment fields such as earphone hearing aids), pharmaceutical applications (fields such as dosage management systems), IoT fields, space and deep sea applications (for example, fields such as a space probe and a submersible.), and the like.

### DESCRIPTION OF REFERENCE SYMBOLS

1, 21, 31, 41, 110, 210: Electrode layer (positive electrode layer)

1′, 21′, 31′, 41′: Active material part (positive electrode active material part)

2, 22, 32, 42, 120, 220: Electrode layer (negative electrode layer)

2′, 22′, 32′, 42′: Active material part (negative electrode active material part)

3, 23, 33, 43, 130, 230: Solid electrolyte layer

4, 24, 34, 44, 140, 240: Insulating part

4a, 24a, 34a, 44a, 240a: Insulating part (positive electrode side)

4b, 24b, 34b, 44b, 240b: Insulating part (negative electrode side)

5, 25, 35, 45, 150, 250: Solid state battery laminate

6: External terminal

6A, 26A, 36A, 46A, 160A, 260A: Positive electrode terminal

6B, 26B, 36B, 46B, 160B, 260B: Negative electrode terminal

10, 20, 30, 40, 100, 200: Solid state battery

21a, 31a, 41a: Positive electrode active material part (upper side)

21b, 31b, 41b: Positive electrode active material part (lower side)

21c, 31c, 41c, 211: Positive electrode current collecting layer

X: Boundary region

Xₐ: Boundary region (positive electrode side)

X_{b}: Boundary region (negative electrode side)

S: Sleeve-shaped part

NS: Non-sleeve-shaped part

F: Part where electrode layer is not covered with insulating part

1. A solid state battery comprising:
a solid state battery laminate that includes at least one battery constituent unit including a positive electrode layer, a negative electrode layer, and a solid electrolyte layer interposed between the positive electrode layer and the negative electrode layer;
a positive electrode terminal on a first side surface of the solid state battery laminate;
a negative electrode terminal on a second side surface opposite the first side surface of the solid state battery laminate; and
an insulating part having a sleeve shape in a sectional view of the solid state battery, the insulating part covering an active material part of at least one electrode layer of the positive electrode layer and the negative electrode layer in a boundary region with the external terminal.

2. The solid state battery according to claim 1, wherein the insulating part sandwiches the active material part from above and below in a lamination direction in the sectional view in the boundary region.

3. The solid state battery according to claim 1, wherein the positive electrode layer is electrically connected to the positive electrode terminal in the boundary region.

4. The solid state battery according to claim 1, wherein in the sectional view, a ratio of a length of a part in the sleeve shape of the insulating part to a thickness of the at least one electrode layer is 0.05% to 10%.

5. The solid state battery according to claim 1, wherein in the sectional view, a part in the sleeve shape of the insulating part and the at least one electrode layer are flush with each other.

6. The solid state battery according to claim 1, wherein in the sectional view, a part in the sleeve shape of the insulating part is raised more than a part of the at least one electrode layer that is not covered with the insulating part.

7. The solid state battery according to claim 6, wherein in the sectional view, a part of the insulating part in contact with the external terminal is the part of the at least one electrode layer that is not covered with the insulating part.

8. The solid state battery according to claim 6, wherein in the sectional view, the raised part in the sleeve shape of the insulating part is flush with a part where the insulating part is in contact with the external terminal.

9. The solid state battery according to claim 1, wherein the positive electrode layer includes a current collecting layer that extends inside the insulating part in the sleeve shape in the sectional view.

10. The solid state battery according to claim 1, wherein the positive electrode layer and the negative electrode layer are layers capable of occluding and releasing lithium ions.

11. The solid state battery according to claim 1, wherein the at least one electrode is layer is the positive electrode layer, the insulating part is a first insulating part, and the active material part is a positive electrode active material part, the solid state battery further comprising:
a second insulating part having a sleeve shape in a sectional view of the solid state battery, the second insulating part covering a negative electrode active material part of the negative electrode layer in the boundary region with the external terminal.

12. The solid state battery according to claim 11, wherein a part of the positive electrode active material part that is covered in by the first insulating part and a part of the negative electrode active material part that is covered by the second insulating part overlap each other in a lamination direction of the positive electrode layer, the negative electrode layer, and the solid electrolyte layer.

13. The solid state battery according to claim 12, wherein a length of the overlap is 10 μm to 200 μm in a direction in which the positive electrode terminal and the negative electrode terminal face each other.

14. The solid state battery according to claim 1, wherein a thickness (T_{S}) of the sleeve shape of the insulating part is 1% to 50% with respect to a thickness (T₃) of the solid electrolyte layer.
